(19) United States
(12) Patent Application Publication
(10) Pub. No.: US 2007/0299734 A1
(43) Pub. Date: Dec. 27, 2007

(54) Method and system of synchronized clearing for online group deal

(76) Inventors: He-Sung Lee, Taipei (TW); Steven S. Kan, Taipei City (TW)

Correspondence Address: BIRCH STEWART KOLASCH & BIRCH, PO BOX 747, FALLS CHURCH, VA, 22040-0747, US

(21) Appl. No.: 11/474,328

(22) Filed: Jun. 26, 2006

(51) Int. Cl. G06Q 30/00

(52) U.S. Cl. 705/26

(57) ABSTRACT

A computer implemented method and a computer system of synchronized clearing for online group deal via electronic communications network involve the steps, various means, and associated processing logic to register participants' transaction items of online group deals, aggregate a plurality of transaction measures of said deals, provide a plurality of online group deal clearing conditions for said participants to select, receive at least a designated online group deal clearing condition from each of said participants, confirme said participants' binding deals, establish at least an effective online group deal clearing condition, activate the clearing of said deal, synchronize the clearing of said participants' transactions conforming to said effective online group deal clearing condition, and execute binding deals.

### BACKGROUND OF THE INVENTION

1. Field of the Invention

The present invention relates generally to the field of electronic commerce. More particularly, the present invention relates to method and system of synchronized clearing for online group deal.

2. Description of the Related Art

Discounts to volume sale are usual in commerce and justified by the lowered average cost in raw materials, production, and customer order processing. Retailers would take this cost advantage and offer favored terms for group deal to increase their sales volume, despite individual demand of a group deal member may not be particularly elastic. In implementing a group deal program, retailers need to offer adequate conditions in consumers' favor and guard against business loss as a result of miscalculation of the demand and price elasticity. In addition, after favored conditions are calculated and set, retailers have to bear the burden of less than expected sales when a participant suddenly decides not to join the group deal. For these reasons, it is common to observe in practice that members of a group deal are required to make advanced payment authorization, deposits, or later punishment as degradation of membership. Nevertheless, prior arts of online group deal have not been able to solve the problem of sales uncertainty.

A typical online group deal program works like the following. An e-store sets a targeted volume for an online group deal, with corresponding discount, and publishes it on its website to start taking participants' intent to place an order. When the total registered quantity accumulates and reaches the targeted volume, the e-store sends message informing each member to make payment and complete the online group deal. Apparently, at the time of registering intent to place order, participants of a group deal cannot be sure whether the volume target will be satisfied. This kind of prior art additionally suffers from inflexible favors and turning away potential consumers who prefer a different favor. A specific example is the ‘collective slashing’ system for online group shopping offered by Yahoo-Taiwan's website. The system allows customers to register for the slashing of a particular sales item's price. As the registered transaction volume increases, the price will gradually be lowered to result in a favored discount price for the online group deal and the registered customers can place orders at the favored discount price. Nevertheless, at the time of registration for the ‘collective slashing’, individual participant cannot ascertain the final favored discount price. As a result, not all registered participants would place orders as registered; some may change their minds after registration and some may have registered strategically for a better price. By accepting and clearing individual orders separately at the favored discount price, the system of online group deals leaves e-stores with significant risks of far less actual orders and ensuing business losses.

A different prior art is disclosed in US patent application publication number 20010037257A1. Instead of registering participants' intent to place order, the method and system directly takes participants' orders, without offering group deal discounts, to get the actual volume of total group deal. Based on the actual transaction volume, the method and system calculates a proper group deal discount and then returns the discount to each participant who has placed an order. Under this scheme, an e-store is able to avoid the risk of discrepancy between registered and actual transaction volume. However, each online group deal participant would face risks associated with not only the uncertain actual volume of the online group deal, but also possible opportunism on the part of an e-store in giving discounts.

In other words, there is room to improve prior arts of online group deal. First, the limitation of separately clearing each participant's transaction, as shown in the Yahoo-Taiwan online group shopping example, needs to be overcome such that all participants' transaction can be synchronously cleared. Second, the risk of uncertain group deal discounts needs to be alleviated such that all participants can enjoy their expected favors in joining an online group deal. Third, inflexibility in offering different types of favored transactions and clearing conditions needs to be improved to satisfy the diverse interests and preferences of its participants. Successful improvements on prior arts will not only lead to more participation in online group deal, but also help increase their confidence in completing an online group deal session and make payment.

### SUMMARY OF THE INVENTION

An object of the present invention is to enable synchronized clearing of transactions requested by an online group deal's all participants. A further object of the present invention is to enable every online group deal participant to get favors as expected. Another object of the present invention is to enable the designation of at least a clearing condition by every participant of an online group deal such that diverse consumer preferences can be satisfied.

In accordance with the above-described objects and those that will be become apparent below, a computer implemented method of synchronized clearing for online group deal includes steps of providing promotional plans for online group deal; receiving digitized instructions from participants of online group deals via electronic communications network; registering said participants' transaction items of online group deals; aggregating for each transaction item a plurality of transaction measures of said deals; providing a plurality of online group deal clearing conditions for said participants to select, each of the plurality of said conditions being related to said promotional plans; receiving at least a designated online group deal clearing condition from each of said participants; confirming said participants' binding deals composing of said registered transaction items and said designated clearing conditions; establishing at least an effective online group deal clearing condition for an online group deal; activating the clearing of said deal; synchronizing the clearing of said participants' transactions conforming to said effective group deal clearing condition; and executing binding deals.

According to further embodiments, the present invention involves also a computer system configured to enable synchronized clearing of online group deal, comprising: at least one processor; at least one data storage device; at least one input-output device; at least one network device; and a plurality of processes spawned by said at least one processor, the processes allowing group deal inputs and including processing logic for: providing promotional plans for online group deal; receiving digitized instructions from participants of online group deals via electronic communications network; registering said participants' transaction items of online group deals; aggregating for each transaction item a plurality of transaction measures of said deals; providing a plurality of online group deal clearing conditions for said participants to select, each of the plurality of said conditions being related to said promotional plans; receiving at least a designated online group deal clearing condition from each of said participants; confirming said participants' binding deals composing of said registered transaction items and said designated clearing conditions; establishing at least an effective online group deal clearing condition for an online group deal; activating the clearing of said deal; and synchronizing the clearing of said participants' transactions conforming to said effective group deal clearing condition.

### BRIEF DESCRIPTION OF THE DRAWINGS

FIG. 1 is a block diagram of computer system of synchronized clearing for online group deals via electronic communications network, according to an embodiment of the present invention;

FIG. 2 is a block diagram showing the working relationships of the synchronized clearing system's components of FIG. 1, according to an embodiment of the present invention;

FIG. 3 is a flowchart showing server steps during a customer session, according to an embodiment of the present invention; and

FIG. 4 is a flowchart showing the server's processing steps for synchronized clearing of online group deals, according to an embodiment of the present invention.

### DESCRIPTION OF THE INVENTION

In order to make the purpose, characteristics, and advantages of the present invention easily understandable, the following figures and tables are used to introduce several embodiments of the present invention and describe their working. To avoid unnecessary long description without more insights, only an online group purchase is described in the followings. The case of an online group sale, another application of online group deal, is omitted here because the method and system involved are exactly the same. The elements introduced for the embodiments, therefore, are so intended and should not be construed as limitations of the present invention.

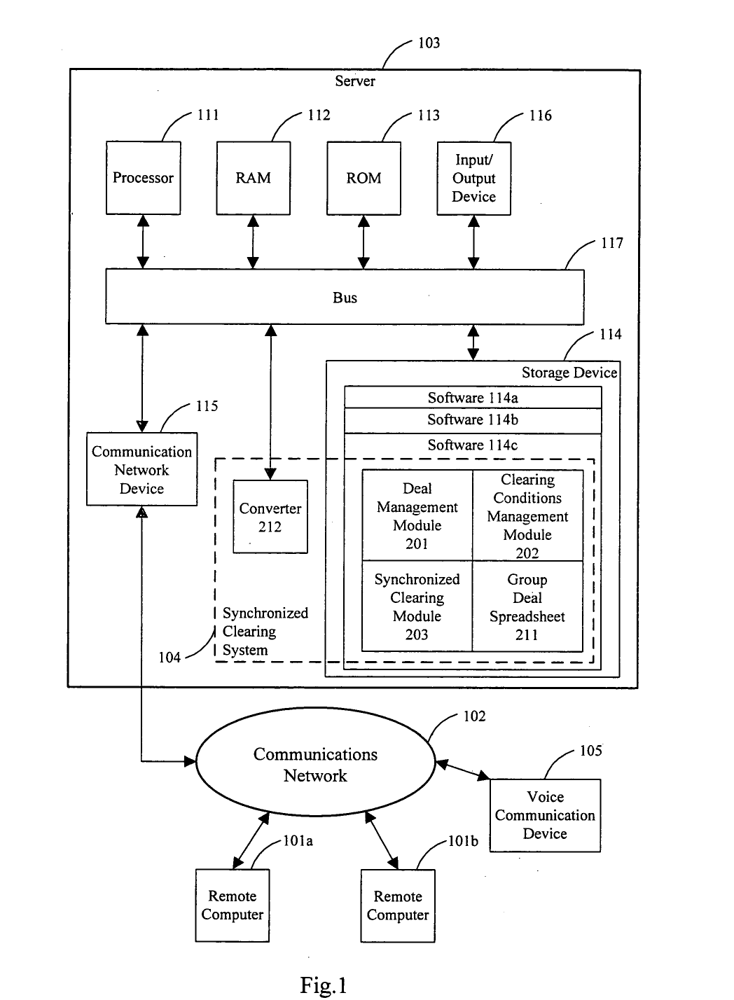

FIG. 1 is a block diagram of present invention's system of synchronized clearing for online group deals via electronic communications network, showing an e-store's server hosting online group deals and its corresponding network environment, according to an embodiment of the present invention. Participants of online group deals use remote computers 101a and 101b, or voice communication device 105, to get on a communications network 102, with which an e-store's server 103 is linked. The participants' remote computers include at least a processor, an input/output device, and a device that can connect them with the communications network 102, for example, a modem linking to Internet, or a wireless phone linking to a wireless network. The voice communication device 105 at least includes a voice input/output means, and a cable or wireless means that can connects to the communications network 102. Communications network 102 includes for example, Internet, LAN, Wireless Network, or voice communication network.

Server 103 includes at least a processor 111, a RAM 112, a ROM 113, a storage device 114, a communication network device 115, an input/output device 116, and BUS 117 via which data originated from or destined to above devices are transmitted. The processor 111 includes at least a central processing unit (CPU). The storage device includes at least a hard disk, where the operating system software 114b for server 103, the software of web server and database server 114a, and the software source codes 114c of the synchronized clearing system for online group deal 104 are stored. The synchronized clearing system for online group deal 104 includes at least a deal management module 201, a clearing conditions management module 202, and a synchronized clearing module 203, and further provides an online group deal spreadsheet 211. The network communication device 115 includes means such as a network card and an analog voice receiver that can receive digitized or voice instructions. Additionally, a converter 212 enables the conversion of voice instructions into digitized instructions. Input/output device 116 includes display card, keyboard, and mouse.

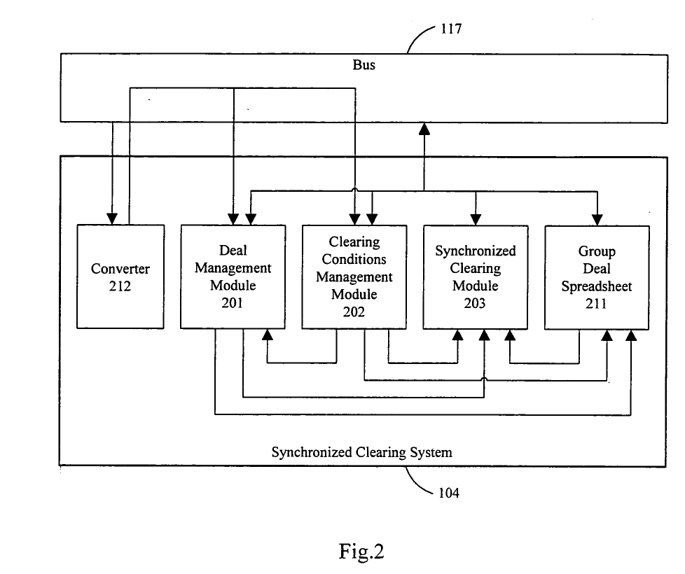

FIG. 2 is a block diagram showing the working relationships of the synchronized clearing system's components of FIG. 1, according to an embodiment of the present invention. The synchronized clearing system includes at least a deal management module 201, a clearing conditions management module 202, and a synchronized clearing module 203. The deal management module 201 provides promotional plans for online group deals on an e-store's website. Participants of online group deal are thereby able to see the promotional plans through their computers. The module receives transaction instructions from participants of online group deal, records transaction items of the participants, and aggregates for each transaction item a plurality of transaction measures related to the promotional plans. The system further provides an online group deal spreadsheet 211 enabling the exhibit of a participant's registered transactions for the participant to inspect and make desirable change, the aggregation of, for each transaction item, a plurality of transaction measures of an online group, and the exhibit of aggregation results for all participants of the online group deal to inspect.

The clearing conditions management module 202 provides a plurality of clearing conditions for participants of online group deal to inspect and select. After enabling them to see the available clearing conditions, the module 202 receives at least a designated online group deal clearing condition from each participant and stores them. The module 202 also confirms if a participant agrees that the registered transactions and designated online group deal conditions will form a binding deal. As shown also in FIG. 2, the computer system of synchronized clearing for online group deal further includes a converter enabling the conversion of voice instructions of transaction items and designations of clearing conditions received from participants of online group deal into digitized instructions and designations. With this converter, the e-store is able to serve participants of online group deal for whom regular telephones or mobile phones are more convenient.

The synchronized clearing module 203 establishes at least an effective online group deal clearing condition for an online group deal. The determination of an effective online group deal clearing condition is based on aggregation results obtained by the deal management module 201 and the designated clearing conditions received by the clearing conditions management module 202. After an effective online group deal clearing condition is established, the synchronized clearing module 203 enables the activation of the clearing of an online group deal and synchronizes the clearing of participants' transactions conforming to the effective online group deal clearing condition. A default activation time is preset by the hosting e-store through the synchronized clearing module 203 in order for the clearing to be automatically activated after an effective online group clearing condition is established. The synchronized clearing module 203 can further enable a representative of an online group deal to bypass the default activation time by transmitting a user interface for the representative to activate the clearing at a desirable time he/she sees fit. In this way an online group deal can be more flexible when there is a representative.

Before going to detailed flowcharts showing the working of an embodiment of the present invention, we use following four tables to indicate some examples of what we mean by promotional plans, registered transactions, online group deal clearing conditions, and designated online group deal clearing conditions. Table 1 gives some examples of promotional plans that can be offered by an e-store hosting online group deals. For instance, in plan 1, when the group deal volume accumulates to 30, 40, and 50, respectively, the discount to a participant of the online group deal increases from 10%, 20%, to 30%, respectively. A promotional plan can also include, for example, the mix of a group deal volume and a participant's individual deal. For instance, a participant can get 15% discount when the group deal volume reaches 30 and the participant's individual deal reaches 10, as in plan 2. Moreover, a promotional plan can also be a mix of items M and N. For instance, 10% discount on M and 20% discount on N can be offered when the total volume for M and N reaches 30, as in plan 3. Discount is only a kind of group deal favor; other kinds of favor may include gifts, bonus points, service upgrades, and coupons that can be easily aggregated. For example, a unit of N can be a gift to every participant of plan 4 when the volume of M reaches 60. Similarly, the participant can choose 5 bonus points instead. Actual promotional plans are to win good will from frequent customers but not limited by the examples shown here.

TABLE 1
Promotional Plans

| Plan | Item and Volume | Favors |
|---|---|---|
| 1 | M: Group Deals of | Discounts: |
| | 30, 40, 50, respectively | 10%, 20%, 30%, respectively |
| 2 | M: Group Deal of 30 and | Discount: |
| | Individual Deal of 10 | 15% |
| 3 | M and N: Group Deal of | Discount on M: 10% |
| | 30 | Discount on N: 20% |
| 4 | M: Group Deal of 60 | Gift: 1 Unit of N or |
| | | Bonus Point: 5 |

As shown in Table 2, our online group deal spreadsheet enables the exhibit of registered transactions for participants to inspect and make desirable change. For example, according to an embodiment of the present invention, participant 1 is able to see that he has registered a transaction for M with 10 units and another transaction for L, also with 10 units. Similarly, participant 2, 3, 4 and 5 can tell from the exhibit their registered transactions for M, N, L, and K. Without going through associated details, we note here in passing that the online group deal spreadsheet can offer various exhibits for different purposes. For instance, for privacy reason, an exhibit of a participant's past transaction record can be displayed only after the participant invokes the specific function provided by the online group deal spreadsheet. Additionally, the online group deal spreadsheet enables the aggregation of, for each transaction item, a plurality of transaction measures. The plurality of transaction measures of an online group deal includes at least one of: a transaction item's total quantity, a transaction item's total payment, a transaction item's total number of participants, the total quantity of a promotional gift earned by said participants, the total accumulated points of a promotion plan earned by said participants, and total number of service upgrades earned by said participants.

TABLE 2
Examples of Registered Transactions

| | |
|---|---|
| Participant | Registered Transactions (units) |

| | | | | |
|---|---|---|---|---|
| 1 | M: 10 | N: 0 | L: 10 | K: 0 |
| 2 | M: 5 | N: 5 | L: 0 | K: 5 |
| 3 | M: 10 | N: 10 | L: 20 | K: 0 |
| 4 | M: 20 | N: 5 | L: 0 | K: 10 |
| 5 | M: 10 | N: 0 | L: 10 | K: 0 |

Table 3 is an example of online group deal clearing conditions announced by the hosting e-store for participants to select. An online group deal clearing condition comprises at least a promotional item on which clearing will be based and a corresponding target on which a clearing will be activated. An example of such a clearing condition is called A in Table 3, where the promotional item is N and the target is zero. It means that the participant selecting A would prefer a clearing to be activated immediately. In this case, the system can establish an effective clearing condition rather easily and synchronize the clearing of all participants' transactions without reference to what exactly the total volume is. On the other hand, the clearing condition B means that a total purchase of $300 on N will trigger the activation of synchronized clearing. The clearing condition X of Table 3, for example, means that the participant selecting X prefers a clearing to be activated when the volume of M reaches 30 units. A clearing condition can also take other forms. For instance, the clearing condition Y means that the participant selecting it prefers a clearing to be activated when total volume of M and L reaches 60. On the other hands the clearing condition Z means that a participant would prefer a clearing to be activated when total gifts reaches 30, or total service upgrades reaches 20. The example of clearing condition Z further shows the flexibility therein; particularly, the participant selecting Z prefers the clearing be activated on two different favors instead of the deal item per se.

TABLE 3
Online Group Deal Clearing Conditions

| Clearing | |
|---|---|
| Condition | Item-Target |
| A | N: 0 |
| B | N: $300 |
| X | M: 30 Units |
| Y | M and L: 60 Units |
| Z | Gift: 30 Units |
| | or Service Upgrades: 20 Units |

Table 4 shows some examples of participants' designated clearing conditions. As shown in the table, participant 1 designates (X,Y,Z) as her designated clearing conditions. It shows that a participant can designate more than one clearing condition from the online group deal clearing conditions announced by the e-store host. A participant is allowed to designate one clearing condition only also, as participant 2 designates Z in Table 4. The examples of participant 3, 4, 5 of Table 4, on the other hand, show the flexibility provided by this invention for participants to express their clearing preferences. For instance, comparing the examples of (Y,A) and (Y,B), we can see that participant 3 is marginally more interested in an immediate clearing based on the transaction volume of N than participant 4. In a similar comparison between (Y,B) and (Y,X), we can see that participant 4 is marginally more interested in a clearing based on item N, instead of M, than participant 5. The flexibility shown above should be able to encourage consumers of various preferences to join online group deals.

TABLE 4
Participants' Designated Clearing Conditions

| Participant | Designated clearing conditions |
|---|---|
| 1 | X, Y, Z |
| 2 | Z |
| 3 | Y, A |
| 4 | Y, B |
| 5 | Y, X |

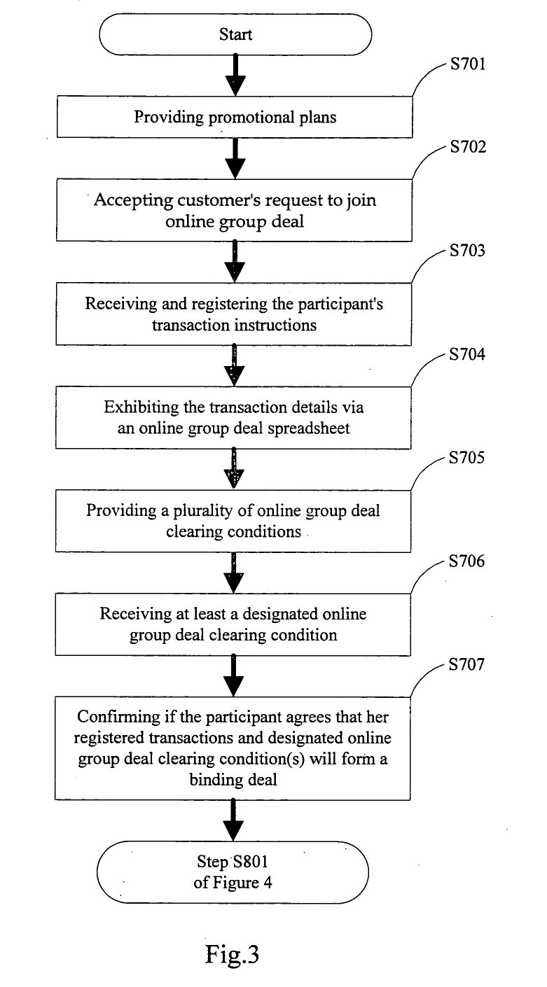

Let's now look at the flowcharts. FIG. 3 is a flowchart showing the steps taken by hosting server during a customer session of the computer implemented method of synchronized clearing for online group deal, according to an embodiment of the present invention. The method of FIG. 3 presupposes that the customer is already on the online e-store's web page. As shown in FIG. 3 at step S701, the e-store's hosting server provides promotional plans on its web pages to attract interested consumers to join an online group deal. At step S702, the hosting server accepts a request to join an online group deal and enables the interested customer to be a participant of the online group deal. After the participant has made decisions on desired transactions through, for instance, product catalog on the web pages, the hosting server at step S703 receives the participant's instructions for the online group deal and records them. At step S704, the hosting server exhibits the transaction details via an online group deal spreadsheet for the participant to inspect and make desirable change. The hosting server at step S705 provides a plurality of online group deal clearing conditions for the participant to consider and select. At step S706, the hosting server receives at least a designated online group deal clearing condition from the participant. At step S707, the hosting server confirms if a participant agrees that her registered transactions and designated online group deal clearing conditions will form a binding deal, one of whose terms and condition stipulates that synchronized clearing and associated processing logic will be based on the binding registered transactions and designated online group deal clearing conditions. A participant's interactive session with the hosting server is then completed.

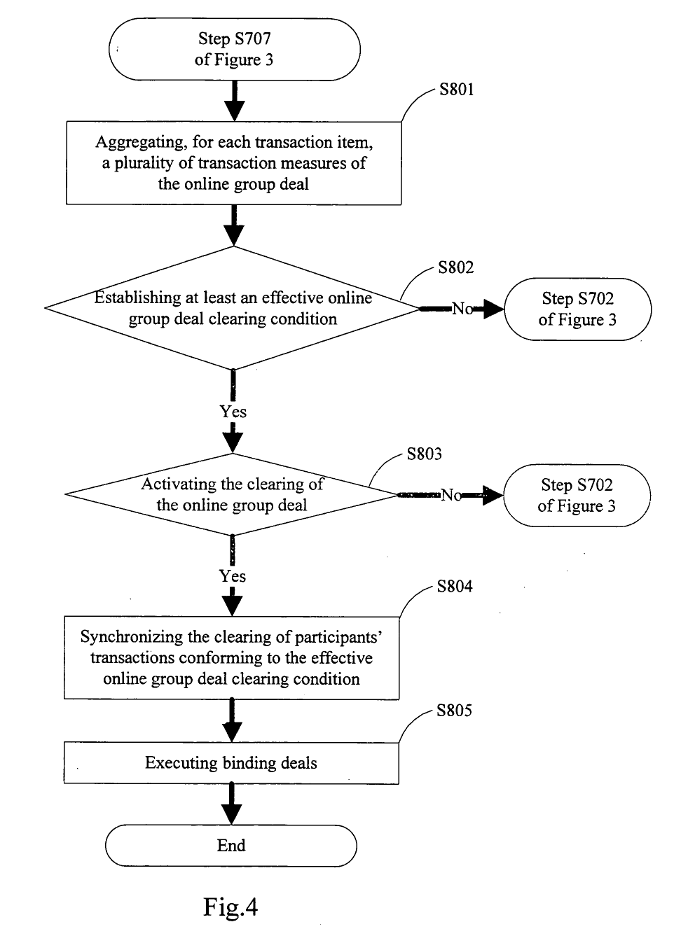

Additionally, steps taken by hosting server are involved to synchronize the clearing of an online group deal for all its participants' transactions. FIG. 4 is a flowchart showing an example of the steps of synchronized clearing, according to an embodiment of the present invention. As shown in FIG. 4, the hosting server at step S801 aggregates, via the online group deal spreadsheet, for each transaction item, a plurality of transaction measures of the online group deal. As explained earlier, the transaction measures includes at least one of: a transaction item's total quantity, a transaction item's total payment, a transaction item's total number of participants, the total quantity of a promotional gift earned by said participants, the total accumulated points of a promotion plan earned by said participants, and total number of service upgrades earned by said participants. The aggregation results are stored automatically and participants of online group deal can inspect them by pulling out the online group deal spreadsheet.

At step S802 the hosting server starts a loop to establish at least an effective online group deal clearing condition. If there exists no effective online group deal clearing condition, the hosting server goes back to step S702. If yes, the hosting server moves on to step S803. The determination of whether there exists an effective online group deal clearing condition is based on two sets of data. The first set of data relates to participants' designated online group deal clearing conditions and is obtained via step S706 of FIG. 3. The second set of data is obtained in step S801.

An example is used below to show the determination logic to establish an effective clearing condition, according to an embodiment of the present invention. First, the system always establishes A as an effective clearing condition because the transaction of N is always equal to or greater than 0, as the example shown in Table 3. In this case the transaction of participant 3, who has designated A as in Table. 4, will be cleared right away as an individual deal; namely, there is no meaningful group deal for the participant. A more meaningful explanation of the establishment of an effective clearing condition is as follows. Let us consider the case where only participants 1, 2, and 3 have joined an online group deal and their transaction details are those shown in Table 2. Suppose further that their designated online group deal clearing conditions are those shown in Table 4, where the definitions of the designated online group clearing condition are shown in Table 3. Moreover, we assume here that the promotional plan only involves discounts but not other types of favors. It's apparent that Z is not an effective online group clearing condition because the promotional plan does not give out gifts or service upgrades. As mentioned above, A is always effective and participant 3 has already been cleared. The system then checks if X, the clearing condition designated by participant 1 only, can be established as an effective clearing condition. It cannot because participant 1's transaction quantity is only 10, which does not satisfy the required 30 units of X. Similarly, Y is not an effective clearing condition, because participants 1 and 3's relevant total transaction quantity is 50, 20 for M and 30 for L, not conforming to the required 60 of Y. The hosting server therefore goes back to step S702 to wait for more participants to join the online group deal.

Maintain the same example and let us consider what happens after participant 4 joins the online group deal, whose transaction and designated online group deal clearing condition data are also shown in Table 2 and Table 4. The aggregation result of S801 at this time shows that Y the relevant total transaction quantity of M and L after the addition of participant 4 becomes 70, 40 for M and 30 for L, which satisfies the required minimum of 60. Thus, Y is now established as the effective clearing condition.

Once an effective online group deal clearing condition is established, the hosting server proceeds to the next step S803. At step S803, the hosting server activates the clearing of an online group deal. The e-store may preset a predetermined activation time, according to an embodiment of the present invention, and the activation of a clearing can be immediately started after an effective clearing condition is established. Alternatively, if time is not a pressure, activation can wait till the predetermined time is reached to allow for more transactions that can earn better favors for participants. When this is the case, the hosting server returns to step S702 of FIG. 3.

It may happen that more than one designated clearing conditions will become effective clearing conditions. According to an embodiment of the present invention, the method and system may prioritize the effective clearing condition as one that maximizes the e-store's revenue. Alternatively, the system may prioritize the effective clearing condition as one that maximizes the number of participants. It's apparent that many other ways in establishing the priority are possible and the above examples are not to limit the applicability of the present invention. In any event, the step S802 of FIG. 4 symbolizes also that the effective clearing condition will be established when there are multiple effective clearing conditions.

According to another embodiment of the present invention that allows more flexibility when there is a representative organizing an online group deal, the step S803 further includes a step wherein the hosting server enables the representative to activate a clearing through transmitted user interface. In this case, the hosting server will proceed to step S804 after receiving the representative's activation instruction.

At step S804 the hosting server synchronizes the clearing of participants' transactions conforming to the effective online group deal clearing condition. Using our last example, the synchronized clearing means that the registered transactions of participants 1, 3, 4, and 5 are cleared at the same time because they all have designated Y as one of their designated clearing conditions and the system has established Y as the effective clearing condition. At this step S804, registered transactions and relevant discounts or favors of the four participants, as shown in Table 2 and Table 1, respectively, are arranged with other necessary data into binding deals. The necessary data include total proceeds, name, and address, etc; The hosting server then moves on to step S805 and executes the final step of the online group deal. The execution step S805 further includes the steps of storing the binding deal, exhibiting the binding deal, and sending it to each participant who has been synchronously cleared, according to an embodiment of the present invention.

Having described and illustrated the principles of the present invention with reference to several embodiments, it will be apparent that the invention can be adapted or modified in arrangement and detail without departing from such principles. As such, it should be recognized that the detailed description is illustrative only and should not be taken as limiting the scope of the present invention, and the spirit of the following claims and equivalents.

What is claimed is:

1. A computer implemented method of synchronized clearing for online group deal via electronic communications network, comprising the steps of: providing promotional plans for online group deal; receiving digitized instructions from participants of online group deals via electronic communications network; registering said participants' transaction items of online group deals; aggregating for each transaction item a plurality of transaction measures of said deals; providing a plurality of online group deal clearing conditions for said participants to select, each of the plurality of said conditions being related to said promotional plans; receiving at least a designated online group deal clearing condition from each of said participants; confirming said participants' binding deals composing of said registered transaction items and said designated clearing conditions; establishing at least an effective online group deal clearing condition for an online group deal; activating the clearing of said deal; synchronizing the clearing of said participants' transactions conforming to said effective online group deal clearing condition; and executing binding deals.

2. The method of claim 1, further including the step of converting said participants' voice instructions and voice designations of group deal clearing conditions via electronic communications network into digitized instructions and digitized designations of group deal clearing conditions.

3. The method of claim 1, wherein before the aggregating step, further including the step of: providing an online group deal spreadsheet enabling the exhibit of said participant's transaction items for said participant to inspect and make desirable change, the aggregation of, for each transaction item, a plurality of transaction measures of said deal, and the exhibit of results of said aggregation for all said participants to inspect.

4. The method of claim 1, wherein the aggregating step's a plurality of transaction measures of an online group deal includes at least one of: a transaction item's total quantity, a transaction item's total payment, a transaction item's total number of participants, the total quantity of a promotional gift earned by said participants, the total accumulated points of a promotion plan earned by said participants, and total number of service upgrades earned by said participants.

5. The method of claim 1, wherein the plurality of group deal clearing conditions being related to promotional plans includes at least one of: total quantity, total payment, total number of participants, total quantity of promotional gifts earned, total accumulated points earned, and total number of promotional service upgrades earned.

6. The method of claim 1, wherein the step of establishing at least an effective online group deal clearing condition for an online group deal, further including the step of prioritizing for the effective online group deal when more then one online group deal clearing conditions have been established as effective.

7. The method of claim 6, wherein the prioritizing criterion includes one of: maximal total revenue, maximal amount of favors earned, and maximal number of participants.

8. The method of claim 1, wherein the activating step further includes a predetermined activation time set by the e-store.

9. The method of claim 1, wherein the activating step further including the step of providing a user interface enabling a representative of an online group deal to activate the clearing of said deal.

10. The method of claim 1, wherein the step of synchronizing the clearing of said participants' transactions conforming to said effective online group deal clearing condition further including the steps of: rearranging relevant data of said participants' transactions into binding deals.

11. The method of claim 1, wherein the step of executing binding deals further including the steps of storing said binding deals, exhibiting said binding deals, and sending said binding deals to said participants.

12. A computer system configured to enable synchronized clearing for online group deals via electronic communications network, comprising: at least one processor; at least one data storage device; at least one input-output device; at least one network device; and a plurality of processes spawned by said at least one processor, the processes allowing group deal inputs and including processing logic for: providing promotional plans for online group deal; receiving digitized instructions from participants of online group deals via electronic communications network, registering said participants' transaction items of online group deals; aggregating for each transaction item a plurality of transaction measures of said deals; providing a plurality of online group deal clearing conditions for said participants to select, each of the plurality of said conditions being related to said promotional plans; receiving at least a designated online group deal clearing condition from each of said participants; confirming said participants' binding deals composing of said registered transaction items and said designated clearing conditions; establishing at least an effective online group deal clearing condition for an online group deal; activating the clearing of said deal; synchronizing the clearing of said participants' transactions conforming to said effective online group deal clearing condition; and executing binding deals.

13. The computer system of claim 12, further including the step of converting said participants' voice instructions and voice designations of group deal clearing conditions via electronic communications network into digitized instructions and digitized designations of group deal clearing conditions.

14. The computer system of claim 12, wherein before the aggregating step, further including the step of: providing an online group deal spreadsheet enabling the exhibit of said participant's transaction items for said participant to inspect and make desirable change, the aggregation of, for each transaction item, a plurality of transaction measures of said deal, and the exhibit of results of said aggregation for all said participants to inspect.

15. The computer system of claim 12, wherein the aggregating step's a plurality of transaction measures of an online group deal includes at least one of: a transaction item's total quantity, a transaction item's total payment, a transaction item's total number of participants, the total quantity of a promotional gift earned by said participants, the total accumulated points of a promotion plan earned by said participants, and the total number of service upgrades earned by said participants.

16. The computer system of claim 12, wherein the plurality of group deal clearing conditions being related to promotional plans includes at least one of: total quantity, total payment, total number of participants, total quantity of promotional gifts earned, total accumulated points earned, and total number of promotional service upgrades earned.

17. The computer system of claim 12, wherein the step of establishing at least an effective online group deal clearing condition for an online group deal, further including the step of prioritizing for the effective online group deal when more then one online group deal clearing conditions have been established as effective.

18. The computer system of claim 17, wherein the prioritizing criterion includes one of: maximal total revenue, maximal amount of favors earned, or maximal number of participants.

19. The computer system of claim 12, wherein the activating step further includes a predetermined activation time set by the e-store.

20. The computer system of claim 12, wherein the activating step further including the step of providing a user interface enabling a representative of an online group deal to activate the clearing of said deal.

21. The computer system of claim 12, wherein the step of synchronizing the clearing of said participants' transactions conforming to said effective online group deal clearing condition further including the steps of: rearranging relevant data of said participants' transactions into binding deals.

22. The computer system of claim 12, wherein the step of executing binding deals further including the steps of storing said binding deals, exhibiting said binding deals, and sending said binding deals to said participants.
